(19) United States
(12) Patent Application Publication
(10) Pub. No.: US 2024/0139558 A1
(43) Pub. Date: May 2, 2024

(54) APPARATUS AND METHOD FOR AIRFLOW ADJUSTMENT IN RESPIRATORY PROTECTIVE DEVICE

(71) Applicant: HONEYWELL INTERNATIONAL INC., Charlotte, NC (US)

(72) Inventors: En Yi CHEN, Charlotte, NC (US); Hang TIAN, Charlotte, NC (US); Xiaojin HAN, Charlotte, NC (US)

(21) Appl. No.: 18/483,147

(22) Filed: Oct. 9, 2023

(30) Foreign Application Priority Data
Oct. 28, 2022 (CN) 202211335586.8

(51) Int. Cl. A62B 18/10; A62B 18/00; A62B 18/08

(52) U.S. Cl. CPC A62B 18/10; A62B 18/006; A62B 18/08

(57) ABSTRACT

Various embodiments are directed to apparatuses and methods for airflow adjustment in a respiratory protective device. In various embodiments, an air distribution system configured for selectively adjusting an airflow in a respiratory protective device, the air distribution system comprising a motor element; and one or more plate element configured for movement between a first and a second directional configurations based on an operation of the motor element; wherein the plate element is configured for arrangement relative to an air outlet of a fan component of the respiratory protective device such that the movement of the plate element between the first directional configuration and the second directional configuration defines a selective adjustment of an airflow characteristic defined by a volume of air flowing through the respiratory protective device relative to the air distribution system.

### CROSS-REFERENCE TO RELATED

This application claims priority pursuant to 35 U.S.C. 119(a) to Chinese Application No. 202211335586.8, filed Oct. 28, 2022, which application is incorporated herein by reference in its entirety.

### FIELD OF THE INVENTION

Example embodiments of the present disclosure relate generally to respiratory protective devices and, more particularly, to an air distribution system for a respiratory protective device configured for selectively adjusting an airflow within the respiratory protective device.

### BACKGROUND

Applicant has identified many technical challenges and difficulties associated with respiratory protective devices. For example, there is a lack of effective methods for adjusting an airflow generated by a centrifugal fan component within a respiratory protective devices. Through applied effort, ingenuity, and innovation, Applicant has solved problems related to these respiratory protective devices embodied in the present disclosure, which are described in detail below.

### BRIEF SUMMARY

Various embodiments are directed to respiratory protective devices and methods of using the same. In various embodiments, an air distribution system for selectively adjusting airflow in a respiratory protective device may comprise a motor element; and one or more plate element configured for movement between at least a first directional configuration and a second directional configuration based at least in part on an operation of the motor element; wherein the one or more plate element is configured for arrangement relative to an air outlet defined by a fan component of the respiratory protective device such that the movement of the one or more plate elements between the first directional configuration and the second directional configuration defines a selective adjustment of one or more airflow characteristic defined by a volume of air flowing through the respiratory protective device relative to the air distribution system.

In various embodiments, the one or more airflow characteristic defined by the volume of air may comprise an airflow direction, and wherein the selective adjustment of the one or more airflow characteristic may be defined by a change in the airflow direction defined by the volume of air from a first airflow direction to a second airflow direction. In various embodiments, the one or more airflow characteristic defined by the volume of air may comprise an airflow volume, and wherein the selective adjustment of the one or more airflow characteristic may be defined by a change in the airflow volume defined by the volume of air from a first airflow volume to a second airflow volume. In various embodiments, the motor element may be configured for electronic communication with a controller component defined by the respiratory protective device. In certain embodiments, the motor element may be configured to drive the movement of the one or more plate element between the first directional configuration and the second directional configuration based at least in part on one or more control signals received from the controller component.

In various embodiments, the air distribution system may further comprise a linking element configured to operably connect the motor element to the one or more plate elements. In certain embodiments, the motor element may define a motor cam element that is selectively configurable between a first motor cam position and a second cam motor position based at least in part on a rotational configuration of a drive shaft defined by the motor element. In various embodiments, the motor cam element may be physically engaged with the linking element such that an arrangement of the motor cam element between the first motor cam position and the motor second cam position causes a corresponding movement of the linking element. In various embodiments, the corresponding movement of the linking element caused by the arrangement of the motor cam element at least partially defines the movement of the one or more plate element between the first directional configuration and the second directional configuration. In certain embodiments, the air distribution system may be configured such that a rotation of the motor cam element about a rotational axis defined by a draft shaft causes an at least partially linear movement of the linking element that drives an angular rotation of the one or more plate element about a respective hinge pin.

### BRIEF DESCRIPTION OF THE DRAWINGS

Reference will now be made to the accompanying drawings, which are not necessarily drawn to scale, and wherein:

FIG. 1 illustrates an example perspective view of an example respiratory protective device in accordance with some example embodiments described herein;

FIG. 2A illustrates an example exploded view of an example respiratory protective device in accordance with some example embodiments described herein;

FIG. 2B illustrates an example isolated exploded view of an example respiratory protective device in accordance with some example embodiments described herein;

FIG. 2C illustrates an example rear view of an example respiratory protective device in accordance with some example embodiments described herein;

FIG. 2D illustrates an example isolated front view of an example respiratory protective device in accordance with some example embodiments described herein;

FIG. 3 illustrates an example circuit diagram of an example respiratory protective device in accordance with some example embodiments described herein;

FIG. 4 illustrates an example block diagram of a respiratory protective device evaluation environment in accordance with some example embodiments described herein;

FIG. 5 an example fan component in accordance with some example embodiments described herein;

FIG. 6 illustrates an example isolated perspective view of an example air distribution system and an example fan component for an example respiratory protective device in accordance with some example embodiments described herein;

FIG. 7 illustrates an example motor element of an example air distribution system in accordance with some example embodiments described herein;

FIG. 8 illustrates an example linking element of an example air distribution system in accordance with some example embodiments described herein;

FIG. 9 illustrates an example plate element of an example air distribution system in accordance with some example embodiments described herein; and

FIGS. 10A and 10B illustrate example isolated perspective views of an example air distribution system for an example respiratory protective device in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

Respiratory protective devices (such as, but not limited to, masks, respirators, and/or the like) can protect our health, especially in the COVID-19 pandemic. For example, wearing a respiratory protective device can help slow the spread of the virus, and people are recommended or required to wear masks in indoor public places and outdoors where there is a high risk of COVID-19 transmission (such as crowded events or large gatherings).

As described above, many respiratory protective devices utilizing powered fan components do not provide any mechanism for adjusting the air flow characteristics of a volume of air flowing into the respiratory protective device in order to optimize a user's breathing experience by dynamically adjusting and optimizing airflow characteristics, such as, for example, an airflow volume, an airflow direction, and/or the like, in light of various operating conditions defined by the respiratory protective device.

Further, many respiratory protective devices having fan components use axial fan components that may not be configured to provide high airflow volumes, and thus, do not provide any mechanism for enabling a more comfortable user breathing experience via an increased airflow volume to the user.

Various embodiments of the present disclosure overcome these technical challenges and difficulties. For example, various embodiments of the present disclosure provide methods and apparatuses for adjusting one or more airflow characteristics defining a volume of air received by a respiratory protective device during operation thereof. Further, various embodiments of the present disclosure include a respiratory protective device configured to use at least one centrifugal fan component to facilitate airflow during operation of the device. Further, the present respiratory protective device includes an air distribution system that is selectively adjustable to enable at least a portion of the airflow volume flowing through the fan component to be redirected at least partially away from the nose and/or mouth of the user during operation of the centrifugal fan component in order to mitigate the risk of a hazardous condition resulting from an increased static pressure generated by the fan component. Further, an exemplary respiratory protective device defines a hidden-fan configuration defined by a decreased exposure and/or accessibility to the blades (e.g., inlets, outlets) of the fan component. For at least the reasons provided above, the present respiratory protective device provides a safety-conscious configuration that facilitates a user to comfortably use the respiratory protective device under an operating condition defined by a minimized risk of harm caused by the device.

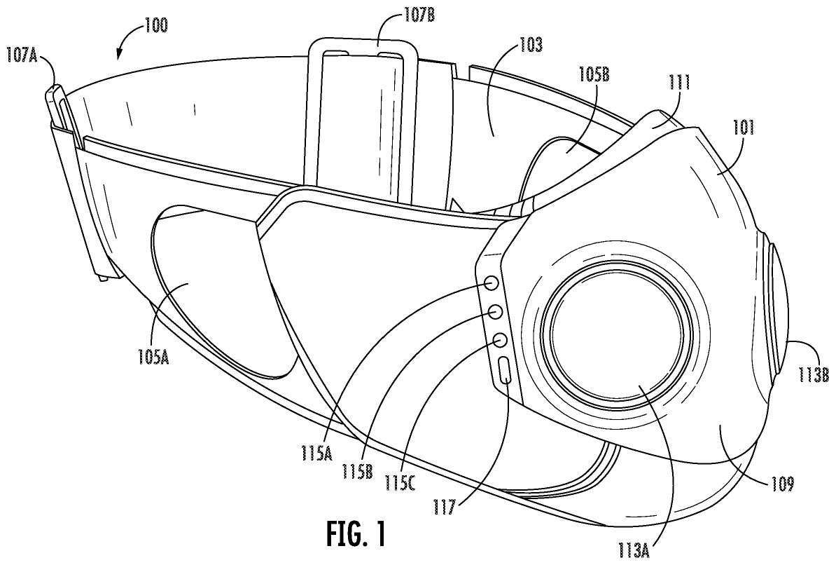

Referring now to FIG. 1, an example perspective view of an example respiratory protective device (also referred to as a respiratory protective equipment) 100 in accordance with some example embodiments described herein is illustrated.

In some embodiments, the example respiratory protective device 100 is in the form of a respirator or a mask. For example, as shown in FIG. 1, the example respiratory protective device 100 comprises a mask component 101 and a strap component 103.

In some embodiments, the strap component 103 may be in the form of a mask strap. For example, in some embodiments, the strap component 103 may comprise elastic material(s) such as, but not limited to, polymers, thermoplastic elastomer (TPE), and/or the like. In some embodiments, the elastic material may allow the example respiratory protective device 100 to be secured to a user's face.

In some embodiments, the strap component 103 may comprise an ear opening 105A and an ear opening 105B. When the example respiratory protective device 100 is worn by a user, the ear opening 105A and the ear opening 105B may allow the user's left ear and the right ear to pass through.

In some embodiments, the strap component 103 may be inserted through one or more strap bucket components (such as a strap bucket component 107A and a strap bucket component 107B as shown in FIG. 1). In some embodiments, the one or more strap bucket components may be in the form of one or more buckles that include, but not limited to, a tri-glide buckle), and may allow a user to adjust the length of the strap component 103 so that the example respiratory protective device 100 can be secured to a user's face.

In some embodiments, the mask component 101 is connected to the strap component 103. For example, a first end of the strap component 103 is connected to a first end of the mask component 101, and a second end of the strap component 103 is connected to a second of the mask component 101. In this example, the first end of the mask component 101 is opposite to the second end of the mask component 101. In the example shown in FIG. 1, an end of the strap component 103 may be secured to the mask component 101 via a fastener component 117 (such as, but not limited to, a snap button).

In some embodiments, the mask component 101 may be in the form of a mask or a respirator. For example, as shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or an inner shell component of the mask component as described herein).

In particular, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. As described above, the example respiratory protective device 100 includes strap component 103 that allows the example respiratory protective device 100 to be secured to the user's face. As such, the face seal component 111 can create at least partially enclosed (or entirely enclosed) space between at least a portion of the user's face (e.g. mouth, nostrils, etc.), details of which are described herein.

In some embodiments, the mask component 101 comprises one or more puck components that cover one or more inhalation filtration components of the example respiratory protective device 100. For example, as shown in FIG. 1, the example respiratory protective device 100 comprises a first puck component 113A that is disposed on a left side of the outer shell component 109 and a second puck component 113B that is disposed on a right side of the outer shell component 109. In such an example, the first puck component 113A covers a first inhalation filtration component that is disposed on the left side of the mask component 101, and the second puck component 113B covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C) that may allow a user to manually control the operations of the fan component of the mask component 101 and/or other devices (such as, but not limited to, earphones) that are in electronic communication with the example respiratory protective device 100.

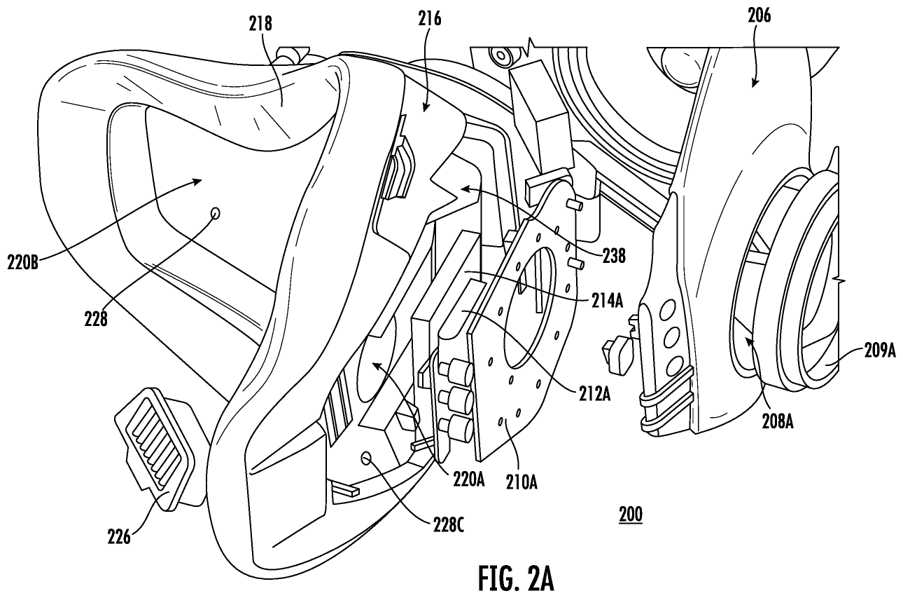

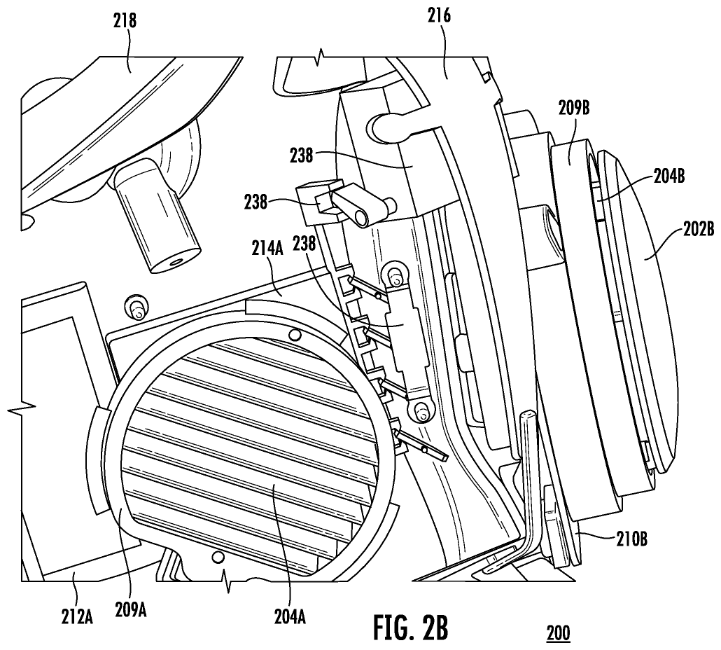

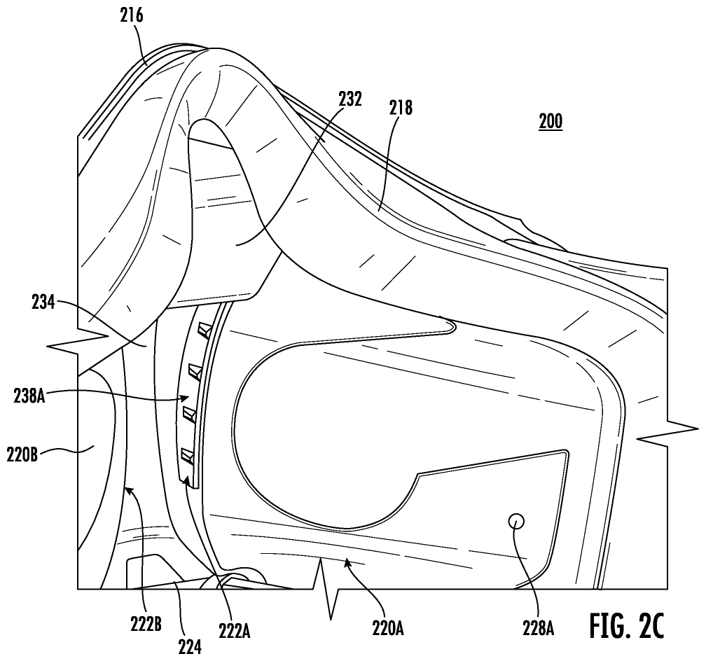

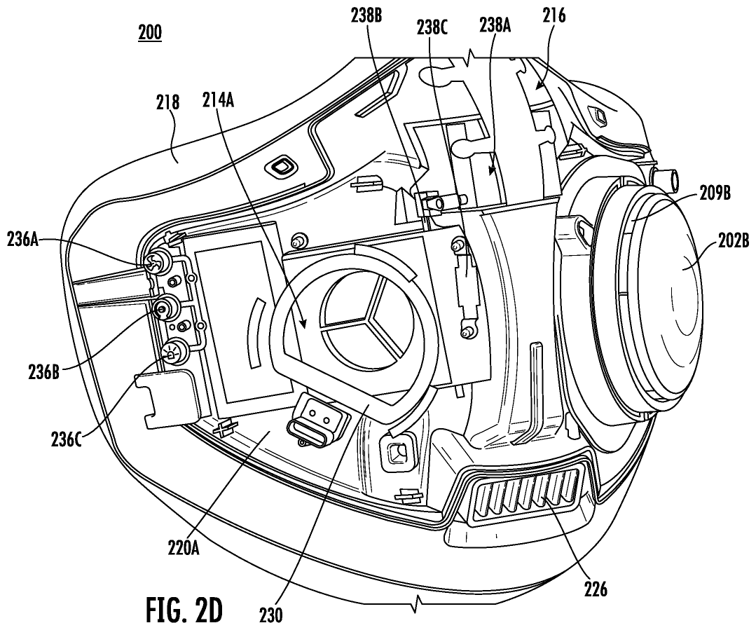

Referring now to FIG. 2A, FIG. 2B, FIG. 2C, and FIG. 2D, examples views of an example respiratory protective device in accordance with some example embodiments described herein are illustrated. In particular, FIG. 2A illustrates an example exploded view of an example respiratory protective device 200 in accordance with some example embodiments described herein, FIG. 2B illustrates an example isolated exploded view of the example respiratory protective device 200 in accordance with some example embodiments described herein, FIG. 2C illustrates an example back view of the example respiratory protective device 200 in accordance with some example embodiments described herein, and FIG. 2D illustrates an example isolated front view of the example respiratory protective device 200 in accordance with some example embodiments described herein.

As shown in FIG. 2A, the respiratory protective device 200 comprises an outer shell component 206 and an inner shell component 216.

In some embodiments, the inner shell component 216 may be in a shape that is based on the contour of the user's face. In particular, when the respiratory protective device 200 is worn by a user, at least a portion of the user's face (such as, but not limited to, mouth, nostrils) are housed within the inner shell component 216.

In some embodiments, the respiratory protective device 200 may comprise a face seal component 218. In some embodiments, the face seal component 218 is attached to and extends from a periphery and/or edge of the inner shell component 216. Similar to the face seal component 111 described above in connection with FIG. 1, the face seal component 216 may comprise soft material such as, but not limited to, silica gel.

In some embodiments, when the respiratory protective device 200 is worn by a user, the face seal component 218 and an inner surface of the inner shell component 216 create an enclosed space on at least a portion of the user's face (e.g. on the mouth, nostrils, etc.).

Similar to the inner shell component 216 described above, the shape of the outer shell component 206 may be based on a contour of the user's face. In some embodiments, when the respiratory protective device 200 is assembled, the inner surface of the outer shell component 206 is secured to an outer surface of the inner shell component 216. In some embodiments, the inner shell component 216 may comprise one or more indentation portions on the outer surface of inner shell component 216.

For example, as illustrated in FIG. 2A, the inner shell component 216 may comprise inner shell indentation portions such as, but not limited to, an inner shell indentation portion 220A that is on a right side of the respiratory protective device 200 and an inner shell indentation portion 220B that is on a left side of the respiratory protective device 200. In particular, each of the inner shell indentation portion 220A and inner shell indentation portion 220B may be sunken or depressed from the outer surface of inner shell component 216. As such, when the outer shell component 206 is secured to the inner shell component 216, the indentation portions may create space that houses electronic components. Further, in various embodiments, the one or more indentation portions defined by the inner shell component 216 of the respiratory protective device 200 may be configured to create a space that at least partially defines an airflow channel specifically configured to facilitate a flow of a volume of air received by a fan component, such as, for example, a centrifugal fan component, at an air inlet and exhausted from the fan component via an air outlet to an interior mask air inlet slot defined at an interior surface of the inner shell component 216.

In various embodiments, one or more circuit board components (such as, but not limited to, a circuit board component 210A), one or more charging circuit components (such as, but not limited to, a charging circuit component 212A), one or more fan components (such as, but not limited to, a fan component 214A), and at least a portion of an air distribution system 238 may be disposed in the space that is defined by the inner shell indentation portion 220A and the inner surface of the outer shell component 206. Similarly, one or more circuit board components (such as, but not limited to, a circuit board component 210B), one or more charging circuit components, and one or more fan components (such as, but not limited to, a fan component 214B) may be disposed in the space that is defined by the inner shell indentation portion 220B and the inner surface of the outer shell component 206. For example, the fan component 214A may be disposed on the right side of the example respiratory protective device 200 and the fan component 214B may be disposed on the left side of the example respiratory protective device 200.

In some embodiments, the circuit board component 210A comprises a circuit board (such as, but not limited to a printed circuit board (PCB)) where other electronic components can be secured to and be in electronic communications with one another. For example, a controller component, the charging circuit component 212A and the fan component 214A may be secured to the circuit board component 210A and be in electronic communication with one another.

In some embodiments, the charging circuit component 212A may comprise a charging circuit and/or a battery that supplies power to the controller component and/or the fan component 214A. For example, the charging circuit may include a Universal Serial Bus (USB) charger circuit that is connected to a rechargeable battery.

In some embodiments, the fan component 214A may comprise an electric fan. In some embodiments, the electric fan of the fan component 214A may operate at different rotation speeds. For example, the fan component 214A may be a stepped fan that provides different, predetermined settings for the rotation speeds. Additionally, or alternatively, the fan component 214A may be a stepless fan that enables continuous adjustment of the rotation speed. In various embodiments, the fan component 214A may define a centrifugal fan comprising an impeller having a plurality of radial impeller blades configured to generate airflow within the fan component 214A by rotating about a central impeller axis. The fan component 214A may be configured such that upon the rotation of an impeller within a fan housing, as described herein, a volume of air may be pulled into an air inlet provided at a top surface of the housing of the fan component 214A, through an impeller intake portion, and pushed (e.g., by the impeller) in an outward radial direction (e.g., away from the central impeller axis) to an air outlet provided at a side surface of the fan component 214A. For example, as described herein, the top surface of the fan component 214A defining the air inlet may at least substantially perpendicular to the side surface defining the air outlet of the fan component 214A. In various embodiments, an exemplary fan component 214A embodying a centrifugal fan may be configured such that the rotation of the impeller causes the volume of air to be pulled into the air inlet from an ambient environment via an air inlet opening 208A defined by the outer shell component 206.

In some embodiments, the electric fan (e.g., the impeller) of the centrifugal fan component 214A may operate at different rotational directions. For example, the fan component 214A may operate in a forward direction or a reverse direction. As an example, when the fan component 214A operates in the forward rotational direction, the electric fan of the fan component 214A may rotate counter-clockwise (when viewing from a user wearing the respiratory protective device 200) and/or may operate as a blower that draws air from outside the respiratory protective device 200 to inside the respiratory protective device 200. As another example, when the fan component 214A operates in the reverse rotational direction, the electric fan of the fan component 214A may rotate clockwise (when viewing from a user wearing the respiratory protective device 200) and/or may operate as an exhaust/ventilation fan that draws air from inside the respiratory protective device 200 to outside the respiratory protective device 200.

In some embodiments, the start time, the stop time, the rotational directions (e.g. forward direction or reverse direction) and/or the rotation speed of the electric fan of the fan component 214A may be controlled and/or adjusted by a controller component of the respiratory protective device 200.

For example, the controller component may transmit a forward rotation start signal to the fan component 214A that causes the fan component 214A to start forward rotation (e.g. start operating as a blower that draws air from outside the respiratory protective device 200 for delivery to an interior portion of the respiratory protective device 200 via the air outlets of the fan component 214A. In some embodiments, the forward rotation start signal may include a forward rotation speed value that indicates the speed for the fan component 214A. Additionally, or alternatively, the controller component may transmit a forward rotation stop signal to the fan component 214A that causes the fan component 214A to stop forward rotation.

Additionally, or alternatively, the controller component may transmit a reverse rotation start signal to the fan component 214A that causes the fan component 214A to start reverse rotation (e.g. start operating as an exhaust fan that draws air from inside the respiratory protective device 200 towards an ambient environment outside the respiratory protective device 200). In some embodiments, the reverse rotation start signal may include a reverse rotation speed value that indicates the speed for the fan component 214A. Additionally, or alternatively, the controller component may transmit a reverse rotation stop signal to the fan component 214A that causes the fan component 214A to stop reverse rotation.

As shown in FIGS. 2A and 2B, the outer shell component 206 of the example respiratory protective device 200 may comprise one or more outer shell indentation portions (such as the outer shell indentation portion 209A and the outer shell indentation portion 209B). In particular, each of the outer shell indentation portions 209A, 209B may be sunken or depressed from the outer surface of outer shell component 206. In some embodiments, one or more inhalation filtration components may be disposed in a respective outer shell indentation portion 209A, 209B. For example, as shown in FIG. 2A, an outer shell indentation portion 209A may have a configuration corresponding to that of an exemplary inhalation filtration component such that the outer shell indentation portion 209A is configured to receive and/or at least partially secure the inhalation filtration component therein.

In some embodiments, each of the one or more outer shell indentation portions may comprise an air inlet opening, and each of the one or more inner shell indentation portions may comprise one or more air inlet slots. In some embodiments, when the respiratory protective device 200 is assembled and in use, the air inlet opening on the outer shell indentation portion is at least partially aligned with the one or more air inlet slots on the inner shell indentation portion. For example, as shown in FIG. 2A, the air inlet opening 208A on the outer shell indentation portion 209A of the outer shell component 206 is at least partially aligned with an air inlet defined by the fan component 214A positioned at the inner shell indentation portion 220A of the inner shell component 216.

In this example, when the respiratory protective device 200 is worn by a user and the user inhales, a volume of air is drawn from the outside (e.g., ambient) environment and travels through an inhalation filtration component disposed within the outer shell indentation portion 209A, through the air inlet opening 208A defined by the outer shell component 206, through a centrifugal fan component 214A (e.g., received via an air inlet) and dispensed into an interior portion defined by the inner shell component 216 (e.g., via the one or more air outlets of the fan component 214A and the interior mask air inlet slot) to arrive at the user's mouth or nostrils. For example, the fan component 214A when the user inhales, the fan component 214A may operate in a forward direction that facilitates a draw of air from outside the respiratory protective device 200 towards an interior portion of the inner shell component 216 (e.g., the interior mask air inlet slot) inside the respiratory protective device 200, thereby facilitating the inhaling of the user. As described herein, an exemplary respiratory protective device 200 may be configured such that the distribution of a volume of air pulled from the ambient environment by the centrifugal fan component 214A may be defined by an increased airflow volume (e.g., relative to an axial fan component) passing through the interior mask air inlet slot that more closely corresponds to nominal user breathing amounts, thereby enabling a less strenuous, more comfortable breathing operation for the user.

In various embodiments, as illustrated in FIGS. 2A, 2B, 2C, and 2D, an exemplary respiratory protective device 200 may comprise an air distribution system 238. In various embodiments, as illustrated, the air distribution system 238 may be at least partially secured relative to the inner shell component 216 such that the air distribution system 238 may be arranged relative to one or more fan components (e.g., fan component 214A) disposed relative to the inner shell component 216. As described herein, the exemplary air distribution system 238 is defined by one or more selectively configurable (e.g., adjustable) components that facilitate an at least substantially uniform airflow distribution of the one or more volumes of air pulled into the device 200 by the one or more fan components (e.g., fan component 214A, fan component 214B) as the respective volumes of air are blown into an interior portion of the inner shell component 216.

Referring now to FIG. 2B, the exemplary respiratory protective device 200 may comprise an air distribution system 238 defining an adjustable configuration that facilitates a selective adjustment of one or more airflow characteristics defined by a volume of air dispensed from an air outlet of a fan component 214A based at least in part on the adjustable arrangement of the air distribution system 238 between one or more configurations and the interaction of the volume of air therewith. The air distribution system 238 may comprise a plurality of plate elements configurable between at least a first and a second directional configuration and positioned relative to the air outlet of the fan component 214A such that the volume of air flowing through the air outlet (e.g., defined along a sidewall surface of the fan housing) of the fan component 214A passes through, engages, and/or otherwise interacts with the plurality of plate elements and is redirected, at least partially impeded, and/or otherwise affected by the arrangement of the plate elements such that an airflow characteristic (e.g., airflow direction, airflow volume) of the volume of air is at least partially changed.

For example, the air distribution system 238 may comprise a plurality of plate elements configurable between at least a first and a second directional configuration and positioned relative to the air outlet of the fan component 214A such that the volume of air flowing through the air outlet (e.g., defined along a sidewall surface of the fan housing) of the fan component 214A passes through, engages, and/or otherwise interacts with the plurality of plate elements and is directed to flow into the interior portion of the inner shell component 216 in a direction corresponding to the directional configuration of the plurality of plate elements. Further, as described herein, the air distribution system 238 (e.g., the plurality of plate elements) may be configured such that an airflow volume defined by the volume of air dispensed from the air outlet of the fan component 214A may be selectively adjusted as it passes through the air distribution system 238 by using a motor-driven cam element to drive a movement (e.g., a rotation) of the plurality of plate elements between various directional configurations (e.g., defined relative to the air outlet) corresponding to various distinct air outlet surface areas through which the volume of air may flow into the interior portion of the inner shell component 216.

As further illustrated in FIG. 2B, the respiratory protective device 200 may comprise one or more inhalation filtration components (such as, but not limited to, inhalation filtration component 204A and inhalation filtration component 204B) and one or more puck components (such as, but not limited to puck component 202B).

In some embodiments, each of the one or more inhalation filtration components may comprise a filter media element that comprise filter material for filtering air. Examples of filter material include, but are not limited to, HEPA filters. In some embodiments, each of the one or more puck components may be positioned to cover one of the inhalation filtration components so as to prolong the lifespan of the respiratory protective device 200. For example, a first puck component may cover the inhalation filtration component 204A arranged relative to the fan component 214A, and a second puck component 202B may cover the inhalation filtration component 204B (e.g., a filter component arranged relative to a second fan component). For example, as shown in FIG. 2B, the inhalation filtration component 204A may be at least partially aligned with an air inlet defined by the fan component 214A such that at least a portion of a volume of air pulled into the respiratory protective device 200 may be received by the fan component 214A at an air inlet thereof upon the at least a portion of the volume of air having passed through the inhalation filtration component 204A.

Referring now to FIG. 2C, an example rear view of the example respiratory protective device 200 is illustrated. In particular, FIG. 2C illustrates the view of the example respiratory protective device 200 when it is worn by a user and viewed by the user, including the interior portion defined by the inner shell component 216 and the face seal component 218.

As shown in FIG. 2C, the example respiratory protective device 200 may comprise an inner shell component 216 that defines an interior mask air inlet slot 222A defining an opening within an inner surface 232 of the inner shell component 216 that is configured to facilitate the flow of a volume of air blown from the air outlet of the fan component 214A into the interior portion of the inner shell component 216 for use (e.g., consumption) by a user wearing the respiratory protective device 200 during one or more breathing operations. As illustrated, the interior mask air inlet slot 222A is configured in a laterally-facing arrangement such that the volume of air flowing from an air outlet defined at a side surface of the centrifugal fan component 214A is directed to flow into the interior portion of the inner shell component 216 in an at least partially lateral direction (e.g., towards the left side of the inner shell component 216). As illustrated, in various embodiments, at least a portion of an exemplary air distribution system, such as, for example, the plurality of plate elements 238A, may be disposed within the interior mask air inlet slot 222A. The plurality of plate elements 238A arranged within the interior mask air inlet slot 222A may be selectively configured between various directional configurations, as described herein, in order to selectively affect and/or adjust an airflow characteristic (e.g., airflow direction) of the volume of air as it passes through the interior mask air inlet slot 222A.

Further, the inner shell component 216 may define a second interior mask air inlet slot 222B defining a second opening within the inner surface 232 of the inner shell component 216 that is configured to facilitate the flow of a second volume of air blown from the air outlet of a second fan component 214B disposed on the left side of the inner shell component 216 into the interior portion of the inner shell component 216 for use (e.g., consumption) by a user wearing the respiratory protective device 200 during one or more breathing operations. As illustrated, the second interior mask air inlet slot 222B is configured in a laterally-facing arrangement such that the volume of air flowing from an air outlet defined at a side surface of the second centrifugal fan component 214B is directed to flow into the interior portion of the inner shell component 216 in an at least partially lateral direction (e.g., towards the right side of the inner shell component 216) that is opposite to the direction defined by the interior mask air inlet slot 222A.

For example, the inner surface 232 of the inner shell component 216 may comprise a nose portion 234, where a user may put his or her nose when the respiratory protective device 200 is worn. In the illustrated embodiment, an interior mask air inlet slot 222A configured to receive a volume of air exhausted from the fan component 214A therethrough may be located at a right side of the nose portion 234, and the second interior mask air inlet slot 222B configured to receive a second volume of air exhausted from the second fan component 214B therethrough may be located at an opposing left side of the nose portion 234 facing at least partially towards the interior mask air inlet slot 222A. As illustrated, the interior mask air inlet slots 222A, 222B may be configured to facilitate the flow of the respective volumes of air dispensed from the respective fan component 214A, 214B and into the interior portion of the inner shell component 216, while the fan components 214A, 214B define an at least partially hidden configuration relative to the interior portion. For example, the interior mask air inlet slots 222A, 222B enable an at least partially hidden arrangement defined by the flow of air being allowed to pass from the fan components 214A, 214B (e.g., via one or more air channels) and through the interior mask air inlet slots 222A, 222B, and the inner surface 232 of the inner shell component 216 functions as a physical barrier to minimize the physical exposure and/or accessibility a user may have to the fan components 214A, 214B (e.g., the impeller blades thereof) from within the interior portion of the inner shell component 216.

In some embodiments, the example respiratory protective device 200 may comprise an outlet opening 224 that is on a middle bottom portion of the inner shell component 216. In some embodiments, the outlet opening 224 may be located corresponding to the position of the user's mouth. For example, when a user exhales, the breath may be released through the outlet opening 224.

As shown in FIG. 2A and FIG. 2D, an exhalation filtration component 226 may be connected to the inner shell component 216 at the outlet opening 224. For example, the exhalation filtration component 226 may cover the outlet opening 224. In some embodiments, the exhalation filtration component 226 may comprise a filter media element that comprise filter material for filtering air. Examples of filter material include, but are not limited to, HEPA filters. As such, the breath that is exhaled by the user may be filtered before it is released from inside the respiratory protective device 200 to the outside (e.g., ambient) environment.

In some embodiments, the respiratory protective device 200 may comprise one or more pressure sensor components. As described above and as shown in FIG. 2A, when the respiratory protective device 200 is worn by a user, the face seal component 218 and an inner surface 232 of the inner shell component 216 create an enclosed space on at least a portion of the user's face (e.g. on the mouth, nostrils, etc.) that defines an interior portion within the inner shell component 216. In some embodiments, a pressure sensor component may comprise a pressure sensor that detects the air pressure within the interior portion defined by this enclosed space between the inner shell component 216 (e.g., the inner surface 232) and the user's face. Examples of the pressure sensor components include, but are not limited to, resistive air pressure transducer or strain gauge, capacitive air pressure transducer, inductive air pressure transducer, and/or the like.

For example, as shown in FIG. 2A, a pressure sensor component 228B may be disposed on the inner shell indentation portion 220B of the inner shell component 216. Additionally, or alternatively, as shown in FIG. 2A, a pressure sensor component 228C may be disposed on the inner shell indentation portion 220A of the inner shell component 216. Additionally, or alternatively, as shown in FIG. 2C, a pressure sensor component 228A may be disposed on an inner surface 234 of the inner shell component 216 (e.g., at inner shell indentation portion 220A). The pressure sensor component 228A, the pressure sensor component 228B, and/or the pressure sensor component 228C may detect the air pressure within the interior portion defined by inner shell component 216 and the face seal component 218 on at least a portion of the user's face.

In some embodiments, the one or more pressure sensor components are in electronic communication with the controller component, and may transmit air pressure indications to the controller component indicating the detected air pressure. For example, each of the air pressure indications may comprise an air pressure value that corresponds to the air pressure in the enclosed space as defined by the face seal component 218 and the inner shell component 216.

As further illustrated in FIG. 2D, in some embodiments, respiratory protective device 200 may include one or more key components, such as, but not limited to, a key component 236A, a key component 236B, and a key component 236C. In some embodiments, the one or more key components may be disposed on an outer surface of the outer shell component 206. Each of the one or more key components 236A, 236B, 236C may provide a button that allow a user to control and/or adjust the operations of various electronic components of the respiratory protective device 200, as described herein (e.g., such as, for example, one or more fan components, earphones, and/or the like).

While the description above provides an example respiratory protective device, it is noted that the scope of the present disclosure is not limited to the description above. In some examples, an example mask component may comprise one or more additional and/or alternative elements. For example, an example respiratory protective device may comprise less than two or more than two fan components. Additionally, or alternatively, an example respiratory protective device may comprise less than two or more than two inhalation filtration components.

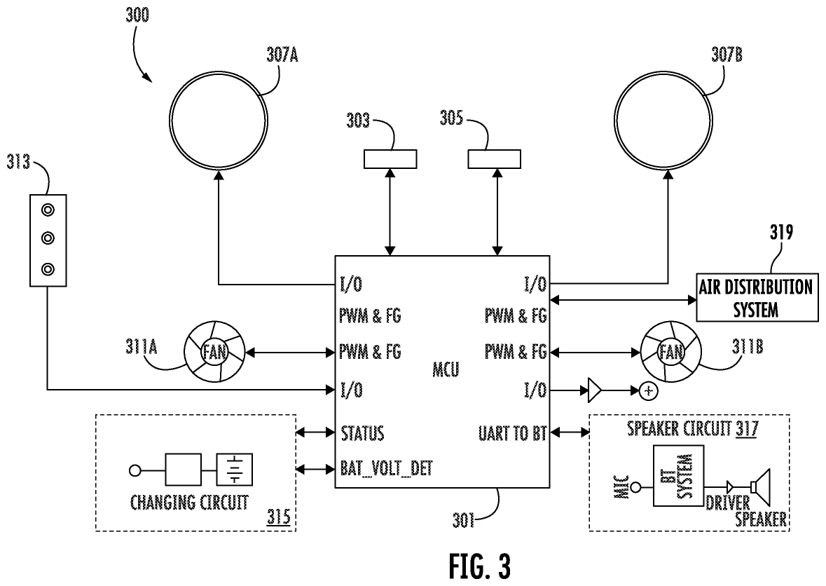

Referring now to FIG. 3, an example circuit diagram of an example respiratory protective device 300 in accordance with some example embodiments described herein is illustrated. In particular, FIG. 3 illustrates example electronic components of an example respiratory protective device in accordance with various example embodiments of the present disclosure.

As shown in FIG. 3, the example respiratory protective device 300 may comprise a controller component 301 that is in electronic communications with other components such as, but not limited to, the pressure sensor component 303, the air quality sensor component 305, a light 307A and a light 307B that are disposed on one or more puck components, fan component 311A, fan component 311B, key components 313, the speaker circuit 317, and/or the air distribution system 319.

In some embodiments, the controller component 301 may be embodied as means including one or more microprocessors with accompanying digital signal processor(s), one or more processor(s) without an accompanying digital signal processor, one or more coprocessors, one or more multicore processors, one or more controllers, processors, one or more computers, various other processing elements including integrated circuits such as, for example, an application specific integrated circuit (ASIC), programmable logic controller (PLC) or field programmable gate array (FPGA), or some combination thereof. Accordingly, although illustrated in FIG. 3 as a single processor, in an embodiment, the controller component 301 may include a plurality of processors and signal processing modules. The plurality of processors may be in operative communication with each other and may be collectively configured to perform one or more functionalities as described herein. In an example embodiment, the controller component 301 may be configured to execute instructions stored in a memory circuitry or otherwise accessible to the controller component.

Whether configured by hardware, firmware/software methods, or by a combination thereof, the controller component 301 may include an entity capable of performing operations according to embodiments of the present disclosure while configured accordingly. Thus, for example, when the controller component 301 is embodied as an ASIC, PLC, FPGA or the like, the controller component 301 may include specifically configured hardware for conducting one or more operations described herein. Alternatively, as another example, when the controller component 301 is embodied as an executor of instructions, such as may be stored in the memory circuitry, the instructions may specifically configure the controller component 301 to perform one or more algorithms and operations described herein.

Thus, the controller component 301 used herein may refer to a programmable microprocessor, microcomputer or multiple processor chip or chips that can be configured by software instructions (applications) to perform a variety of functions, including the functions of the various embodiments described above.

In some embodiments, the memory circuitry may include suitable logic, circuitry, and/or interfaces that are adapted to store a set of instructions that is executable by the controller component 301 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an example embodiment, the memory circuitry may be integrated with the controller component 301 on a single chip, without departing from the scope of the disclosure.

In some embodiments, the pressure sensor component 303 may transmit air pressure indications to the controller component 301. As described above, each of the air pressure indications may comprise an air pressure value that corresponds to the air pressure in the enclosed space as defined by the face seal component 218 and the inner shell component 216.

In some embodiments, the air quality sensor component 305 may transmit air quality indications to the controller component 301. As described above, the air quality indications may indicate a quality of the air in the outer environment, in the enclosed space and/or in the breath exhaled by the user.

In some embodiments, the controller component 301 may transmit control signals to the light 307A and/or the light 307B so as to adjust the color and/or intensity of the light emitted by the light 307A and/or the light 307B.

In some embodiments, the controller component 301 may transmit forward rotation start signals to the fan component 311A and/or the fan component 311B to cause the fan component 311A and/or the fan component 311B to start forward rotation. In some embodiments, the controller component 301 may transmit forward rotation stop signals to the fan component 311A and/or the fan component 311B to cause the fan component 311A and/or the fan component 311B to stop forward rotation.

In some embodiments, the controller component 301 may transmit reverse rotation start signals to the fan component 311A and/or the fan component 311B to cause the fan component 311A and/or the fan component 311B to start reverse rotation. In some embodiments, the controller component 301 may transmit reverse rotation stop signals to the fan component 311A and/or the fan component 311B to cause the fan component 311A and/or the fan component 311B to stop reverse rotation.

In some embodiments, the controller component 301 is in electronic communication with the key components 313. For example, when a user presses a button on the key components 313, the key components 313 may transmit a signal to the controller component 301.

In some embodiments, the controller component 301 is in electronic communication with the speaker circuit 317. For example, the controller component 301 may transmit control signals to an earphone in the speaker circuit 317 so as to adjust volume, noise canceling mode, and/or the like of the earphone.

In some embodiments, the charging circuit 315 supplies power to controller component 301 and one or more other electronic components shown in FIG. 3 (such as, but not limited to, the fan component 311A and the fan component 311B).

In some embodiments, the controller component 301 is in electronic communication with the air distribution system 319. For example, the controller component 301 may transmit control signals to a motor element of the air distribution system 319 so as to operate the motor element to drive a movement of one or more plate elements defined by the air distribution system 319 in order to selectively adjust an air flow characteristic defined by a volume of air flowing through one or more air outlet defined by a fan component (e.g., fan 311A, fan 311B) of the respiratory protective device 300.

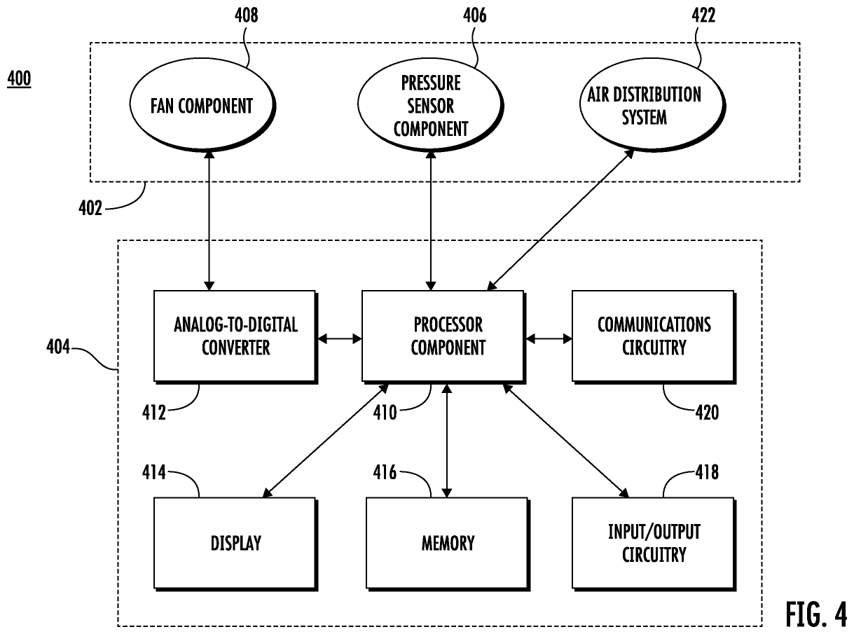

Referring now to FIG. 4, an example block diagram of an example respiratory protective device evaluation environment 400 in accordance with some embodiments of the present disclosure is illustrated.

In some embodiments, the example respiratory protective device evaluation environment 400 comprises an example respiratory protective device 402 and an example respiratory protective device evaluation system 404.

In some embodiments, the example respiratory protective device 402 is similar to the example respiratory protective devices described and illustrated above in connection with FIG. 1 to FIG. 3. For example, the example respiratory protective device 402 may comprise components that include, but not limited to, a mask component similar to those described above in connection with FIG. 1 to FIG. 3 (such as, but not limited to, at least the mask component 101 illustrated above in connection with FIG. 1, and the respiratory protective device 200 illustrated above in connection with FIG. 2A to FIG. 2D). In some embodiments, the example respiratory protective device 402 may comprise various electronic components, such as, but not limited to, those example electronic components described and illustrated above in connection with FIG. 3. For the simplicity of illustration, FIG. 4 illustrates three of the electronic components of the example respiratory protective device 402: a pressure sensor component 406, a fan component 408, and an air distribution system 422.

In some embodiments, the pressure sensor component 406 is similar to the pressure sensor components 228A, 228B, and/or 228C described above in connection with FIG. 2A to FIG. 2C, and/or the pressure sensor component 303 described above in connection with FIG. 3. For example, the pressure sensor component 406 comprises a pressure sensor that detects the air pressure within the enclosed space between the mask component of the example respiratory protective device 402 and the user's face when the example respiratory protective device 402 is worn by the user. Examples of the pressure sensor component 406 include, but are not limited to, barometric pressure sensors, resistive air pressure transducer or strain gauge, capacitive air pressure transducer, airflow velocity sensors, inductive air pressure transducer, spirometers, pneumotachometers, and/or the like. For example, the pressure sensor component 406 generates pressure detection signals, which indicates pressure values within the enclosed space as described above.

In some embodiments, the fan component 408 is similar to the fan components 214A and/or 214B described above in connection with FIG. 2A to FIG. 2C, and/or the fan components 311A and/or 311B described above in connection with FIG. 3. For example, the fan component 408 may comprise an electric fan that blows air into the respiratory protective device 402 when a user wearing the respiratory protective device inhales. As described herein, the fan component 408 may embody a centrifugal fan comprising an impeller having a plurality of radial impeller blades configured to generate airflow within the fan component 408 by rotating about a central impeller axis. In some embodiments, the fan component 408 is connected to a power source (such as, but not limited to, a rechargeable battery) that provides a current and/or a voltage to trigger the operation of the fan component 408. For example, when the current or the voltage is provided to the fan component 408, the fan component 408 starts to operate and blows air into the respiratory protective device. When the current or the voltage is not provided to the fan component 408, the fan component 408 stops operation and stops blowing air into the respiratory protective device.

In some embodiments, the air distribution system 422 is similar to the air distribution system 238 described above in connection with FIGS. 2A, 2B, 2C, and 2D, and/or the air distribution system 319 described above in connection with FIG. 3. In various embodiments, the air distribution system 422 may comprise a motor element, a linking element, and a plurality of plate elements that may be selectively configured relative to the air outlet of a fan component 408 so as to facilitate the selective adjustment of one or more airflow characteristics defined by a volume of air received by the air distribution system 422 from an air outlet of a corresponding fan component 408. For example, the air distribution system 422 facilitates an at least substantially uniform airflow distribution of airflow into the interior portion defined by an inner shell component of the respiratory protective device 402, as described herein.

In the example respiratory protective device evaluation environment 400, the example respiratory protective device 402 may be worn by a testing mannequin. For example, the testing mannequin may comprise an artificial head model that is shaped based on contours and features of a typical human head, and the example respiratory protective device 402 may be secured to the artificial head model of the testing mannequin. In some embodiments, the example respiratory protective device 402 covers at least the mouth and/or the nose of the artificial head model. In some embodiments, the mouth and/or the nose of the artificial head model is connected to an artificial lung that mimics breathing patterns of human beings. For example, the artificial lung is connected to a motor that mimics inhaling and exhaling of human beings.

In some embodiments, the testing mannequin may simulate breathing patterns according to typical breathing patterns when a user is at rest. For example, the testing mannequin may test the example respiratory protective device 402 with a respiratory rate at 20 times per minute. In some embodiments, the testing mannequin may be placed at a testing environment with an environment temperature of 37° C. degrees and a humidity level of 90%. In such a testing environment, the fan component may operate to blow a maximum of 40 liters per minute (LPM) of air into the respiratory protective device 402. In some embodiments, the testing mannequin may simulate breathing patterns according to typical breathing patterns when a user is exercising. For example, the testing mannequin may test the example respiratory protective device 402 with a respiratory rate at 40 times per minute. In some embodiments, the testing mannequin may be placed at a testing environment with an environment temperature of 37° C. degrees and a humidity level of 90%. In such testing environment, the fan component may operate to blow a maximum of 80 liters per minute (LPM) of air into the respiratory protective device 402.

In some embodiments, the example respiratory protective device 402 is connected to the respiratory protective device evaluation system 404 through wired and/or wireless means for data reading, writing, and transfer. In the example shown in FIG. 4, the respiratory protective device evaluation system 404 comprises a processor component 410, an analog-to-digital converter 412, a display 414, a memory 416, an input/output circuitry 418, and a communications circuitry 420.

In the example shown in FIG. 4, the processor component 410 is connected to the pressure sensor component 406 of the respiratory protective device 402. As described above, the pressure sensor component 406 comprises a pressure sensor that detects the air pressure within the enclosed space between the mask component of the example respiratory protective device 402 and the user's face when the example respiratory protective device 402 is worn by the user. In some embodiments, the pressure sensor component 406 generates pressure detection signals that indicate pressures within the enclosed space described above. In some embodiments, the pressure sensor component 406 is connected to the processor component 410 through wired and/or wireless means and provides pressure detection signals to the processor component 410. In some embodiments, the processor component 410 generates pressure measurement parameters based on the pressure detection signals received from the processor component 410.

Further, as shown in FIG. 4, the processor component 410 may be connected to the air distribution system 422 (e.g., a motor element) of the respiratory protective device 402. As described above, the air distribution system 422 comprises a motor element configured to receive one or more control signals defining instructions for selectively reconfiguring the plurality of plate elements defined by the air distribution system 422 in order to adjust an airflow characteristic defined by a volume of air flowing into the interior portion of the inner shell component. The processor component 410 may communicate one or more control signals to the motor element of the air distribution system 422 in order to selectively arrange the air distribution system 422 such that the air flow characteristic of the volume of air is adjusted based on an identified breathing pattern determined by the respiratory protective device 200 as the example respiratory protective device 402 is worn by the user. In some embodiments, the air distribution system 422 (e.g., a motor element defined by the air distribution system 422) is connected to the processor component 410 through wired and/or wireless means. In some embodiments, the processor component 410 generates control signals communicated to the air distribution system 422 to selectively adjust an air flow characteristic defined by a volume of air flowing through one or more air outlet of the fan component 408 based at least in part on one or more operating characteristics and/or breathing conditions defined by the respiratory protective device 402 at a particular instance or period of time.

In some embodiments, the analog-to-digital converter 412 is connected to the fan component 408 of the respiratory protective device 402. As described above, when a current and/or a voltage is provided to the fan component 408, the fan component 408 starts to operate and blows air into the respiratory protective device 402. In some embodiments, the analog-to-digital converter 412 receives an electrical signal that corresponds to the current and/or the voltage that is provided to the fan component 408. For example, the higher the electrical signal that is received by the analog-to-digital converter 412, the higher the current and/or voltage that is provided to the fan component 408, and the faster the fan component 408 operates.

In some embodiments, the analog-to-digital converter 412 converts the electrical signal received from the fan component 408 to a digital signal. For example, the analog-to-digital converter 412 converts the electrical signal into a digital signal that indicates the value of the current and/or the voltage that is provided to the fan component 408. Examples of the analog-to-digital converter 412 include, but are not limited to, direct-conversion analog-to-digital converter (ADC), successive-approximation ADCs, ramp-compare ADCs, and/or the like.

In some embodiments, the analog-to-digital converter 412 is connected to the processor component 410 of the respiratory protective device evaluation system 404 through wired and/or wireless means and provides digital signals to the processor component 410 of the respiratory protective device evaluation system 404. In some embodiments, based on the digital signals received from the analog-to-digital converter 412, the processor component 410 of the respiratory protective device evaluation system 404 generates fan control parameters that indicate the current and/or the voltage that is provided to the fan component 408.

The respiratory protective device evaluation system 404 may be configured to execute the operations described herein. Although components of the respiratory protective device evaluation system 404 are described with respect to functional limitations, it should be understood that the particular implementations necessarily include the use of particular hardware. It should also be understood that certain of the components described herein may include similar or common hardware. For example, two sets of circuitries may both leverage use of the same processor, network interface, storage medium, or the like to perform their associated functions, such that duplicate hardware is not required for each set of circuitries. The use of the term “circuitry” as used herein with respect to components of the apparatus should therefore be understood to include particular hardware configured to perform the functions associated with the particular circuitry as described herein.

As described above, the term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the respiratory protective device evaluation system 404 may provide or supplement the functionality of particular circuitry. For example, the processor component 410 may provide processing functionality, the memory 416 may provide storage functionality, the communications circuitry 420 may provide network interface functionality, and the like.

In some embodiments, the processor component 410 (and/or co-processor or any other processing circuitry assisting or otherwise associated with the processor) may be in communication with the memory 416 via a bus for passing information among components of the apparatus. The memory 416 may be non-transitory and may include, for example, one or more volatile and/or non-volatile memories. In other words, for example, the memory 416 may be an electronic storage device (e.g., a computer readable storage medium). The memory 416 may be configured to store information, data, content, applications, instructions, or the like, for enabling the respiratory protective device evaluation system 404 to carry out various functions in accordance with example embodiments of the present disclosure.

The processor component 410 may be embodied in a number of different ways and may, for example, include one or more processing devices configured to perform independently. Additionally, or alternatively, the processor component 410 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor component 410 may be configured to execute instructions stored in the memory 416 or otherwise accessible to the processor. Alternatively, or additionally, the processor component 410 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor component 410 is embodied as an executor of software instructions, the instructions may specifically configure the processor to perform the algorithms and/or operations described herein when the instructions are executed.

In some embodiments, the respiratory protective device evaluation system 404 may include the input/output circuitry 418 that may, in turn, be in communication with the processor component 410 to provide output to the user and, in some embodiments, to receive an indication of a user input. The input/output circuitry 418 may comprise an interface, a mobile application, a kiosk, or the like. In some embodiments, the input/output circuitry 418 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., the memory 416, and/or the like).

In some embodiments, the respiratory protective device evaluation system 404 may include the display 414 that may, in turn, be in communication with the processor component 410 to display renderings of user interfaces. In various examples of the present disclosure, the display 414 may include a liquid crystal display (LCD), a light-emitting diode (LED) display, a plasma (PDP) display, a quantum dot (QLED) display, and/or the like.

The communications circuitry 420 may be any means such as a device or circuitry embodied in either hardware or a combination of hardware and software that is configured to receive and/or transmit data from/to a network and/or any other device, circuitry, or module in communication with the respiratory protective device evaluation system 404. In this regard, the communications circuitry 420 may include, for example, a network interface for enabling communications with a wired or wireless communication network. For example, the communications circuitry 420 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

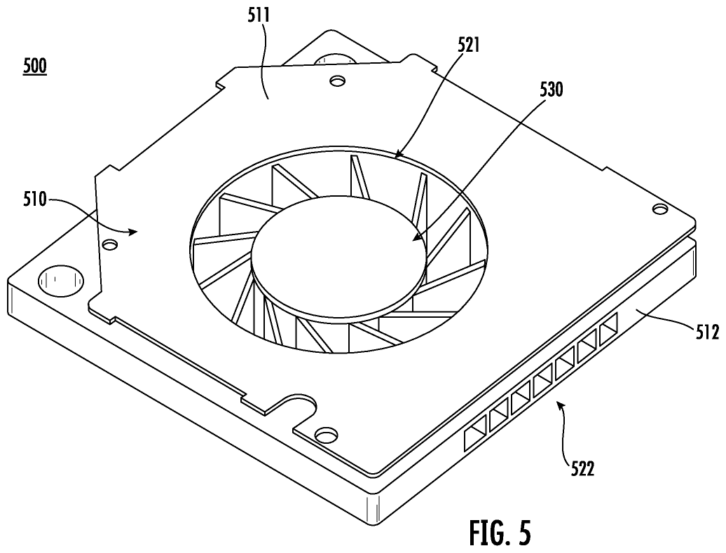

Referring now to FIG. 5, an example fan component 500 in accordance with some example embodiments described herein. In particular, the example fan component 500 is configured for use in a respiratory protective device to facilitate a flow of a volume of air through a respiratory protective device when a user wearing the respiratory protective device inhales. In some embodiments, the fan component 500 is similar to the fan components 214A and/or 214B described above in connection with FIG. 2A to FIG. 2C, the fan components 311A and/or 311B described above in connection with FIG. 3, and/or the fan component 408 described above in connection with FIG. 4.

As described herein, the fan component 500 may embody a centrifugal fan component defined by an impeller 530 that comprises a plurality of radial impeller blades configured to generate airflow within the fan component 500 (e.g., from the air inlet 521 to the air outlet 522) by rotating about a central impeller axis. The fan component 500 may be configured such that upon the rotation of the impeller 530, a volume of air may be pulled into the air inlet 521, moved through an interior portion of the fan component housing 510 by the rotating impeller 530, and pushed in an outward radial direction to the air outlet 522.

In various embodiments, as illustrated in FIG. 5, an exemplary fan component 500 may comprise a fan housing 510 defining an air inlet 521 and an air outlet 522, and an impeller 530 disposed within the fan housing component 510. In various embodiments, the fan component housing 510 may comprise a top surface 511 defining an air inlet 521 therein. For example, the air inlet 521 defined by the fan component 500 may be an opening in the top surface 511 of the fan housing component 510 through which the fan component 500 is configured to pull a volume of air into the fan component 500 during operation of the respiratory protective device using the rotation of the impeller 530. Further, in various embodiments, the fan component housing 510 may comprise a sidewall surface 512 defining an air outlet 522 therein. For example, the air outlet 522 defined by the fan component 500 may be one or more openings provided within the sidewall surface 512 of the fan housing component 510 through which the fan component 500 is configured to dispense (e.g., blow) the volume of air from present within the fan component 500. The fan component 500 may dispense the volume of air through the air outlet 522 using the rotation of the impeller 530 to push the volume of air in an outward radial direction (e.g., away from the central impeller axis defined by the impeller 530) through the air outlet 522.

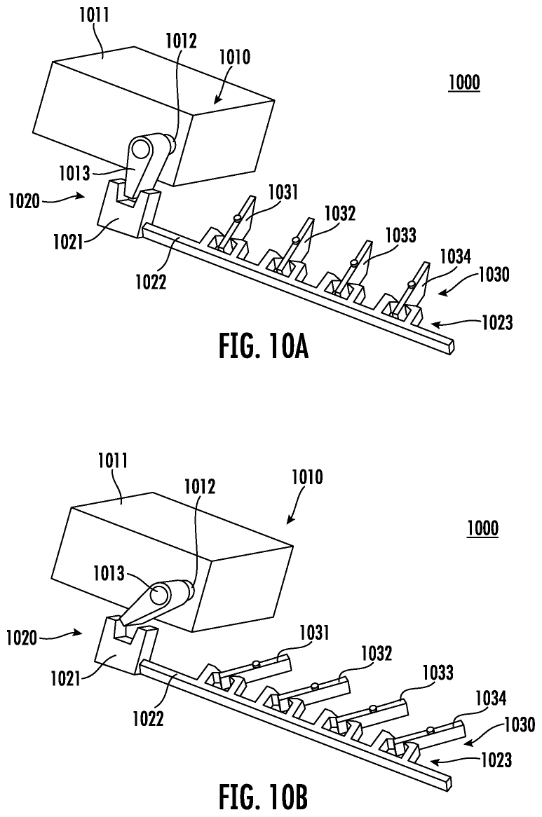

In various embodiments, the air outlet 522 defined by the fan component 500 may be defined by a plurality of openings distributed along the sidewall surface 512 of the fan component housing 510. For example, in various embodiments, the number of openings defining the air outlet 522 of the fan component 500 may correspond to the number of plate elements defined by an air distribution system (e.g., the air distribution system 1000 as described in reference to FIGS. 10A and 10B), as described herein. As a non-limiting example, in an exemplary circumstance wherein an air distribution system of an exemplary respiratory protective device comprises five plate elements configurable between a first and a second directional configuration, the air outlet 522 of the exemplary fan component 500 may be defined by five openings distributed along the sidewall surface 512 in respective positions corresponding to a respective one of the five plate elements of the air distribution sample. For example, the fan component 500 may be arranged relative to the air distribution system such that a movement (e.g., a pivot) of each of the five plate elements between a first and a second directional configuration may result in the five plate elements being rotated angularly towards and away from a respective one of the five openings defining the air outlet 522.

As a non-limiting embodiments provided for illustrative purposes, in such an exemplary configuration, a first directional configuration of the five plate elements may embody the five plate elements being arranged to fully cover an opening area of a respective one of the five openings of the air outlet 522 such that each of the five openings defines a closed (e.g., blocked) configuration that facilitates a maximum airflow volume through the air distribution system. Further, in such an exemplary configuration, a second directional configuration of the five plate elements may embody the five plate elements being arranged to provide a minimal amount of coverage (e.g., interference) over the opening area of the respective one of the five openings of the air outlet 522 such that each of the five openings defines an open configuration that facilitates a maximum airflow volume through the air distribution system.

As illustrated in FIG. 5, the fan component housing 510 of the exemplary centrifugal fan component 500 may define a top surface 511 that defines the air inlet 521 of the fan component 500 and is arranged in an at least substantially perpendicular configuration relative to the sidewall surface 512 of the housing 510 that defines the air outlet 522 of the fan component 500. Accordingly, the fan component 500 is configured such that the rotation of the impeller 530 causes a volume of air to be pulled through the air inlet 521 (e.g., through the top surface 511) in a first flow direction and dispensed through the air outlet 522 (e.g., through the sidewall surface 512) in a second flow direction that is at least substantially perpendicular relative to the first flow direction.

In various embodiments, the fan component 500 may be disposed within the inner shell component of an exemplary respiratory protective device in a position wherein the rotation of the impeller 530 causes a volume of air to be pulled from the ambient environment and through a filtration component of the respiratory protective device, as described herein, defining an upstream position relative to the air inlet 521. In various embodiments, an impeller 530 may be connected to a blower motor configured to drive the rotation of the impeller 530 about the central impeller axis. As an illustrative example, in various embodiments, an exemplary fan component 500 (e.g., a fan component housing 510) of a respiratory protective device may be defined by a fan height of at least approximately between 3.0 mm and 30.0 mm (e.g., between 3.0 mm and 10.0 mm), a fan length of at least approximately between 15.0 mm and 100.0 mm (e.g., between 17.0 mm and 50.0 mm), and a fan width of at least approximately between 15.0 mm and 100.0 mm (e.g., between 17.0 mm and 50.0 mm).

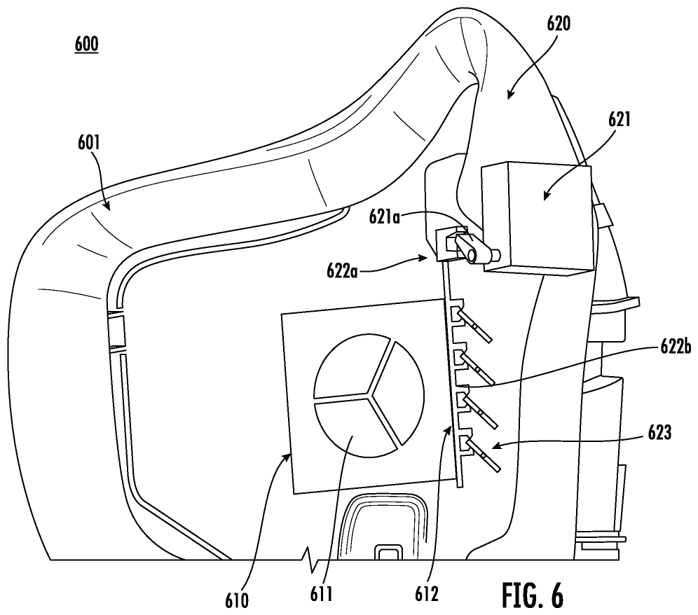

Referring now to FIG. 6, an example isolated perspective view of an example air distribution system and an example fan component for an example respiratory protective device in accordance with some example embodiments described herein is illustrated. In particular, an example respiratory protective device 600 comprising an exemplary fan component 610 and an exemplary air distribution system 620 is shown. For example, the fan component 610 may be similar to the fan components 214A and/or 214B described above in connection with FIG. 2A to FIG. 2C, the fan components 311A and/or 311B described above in connection with FIG. 3, the fan component 408 described above in connection with FIG. 4, and/or the fan component 500 described above in connection with FIG. 5. Further, for example, the air distribution system 620 may be similar to the air distribution system 238 described above in connection with FIGS. 2A, 2B, 2C, and 2D, the air distribution system 319 described above in connection with FIG. 3, and/or the air distribution system 422 described above in connection with FIG. 4.

In various embodiments, as illustrated in FIG. 6, an exemplary respiratory protective device 600 may comprise an air distribution system 620 secured disposed at the inner shell component 601 and arranged relative to the fan component 610 such that the air distribution system 620 is configured to engage, interact with, and/or otherwise direct a volume of air dispensed from the air outlet 612 of the fan component 610 before the volume of air flows into the interior portion of the inner shell component 601, as described herein. Accordingly, the selectively configurable configuration of the air distribution system 620 that enables a selective adjustment of one more airflow characteristics of the volume of fluid based on an arrangement of a linking element 622a, 622b and/or a plurality of plate elements 623 connected thereto. For example, the air distribution system 620 may comprise a plurality of plate elements 623 configurable between a plurality of directional configurations (e.g., relative to the air outlet 612 of the fan component 610) based on one or more motor-driven movements (e.g., linear translations, swings, and/or the like) of a linking element defined by a motor engagement element 622a and a linking rod 622b that operatively connect the plurality of plate elements 623 to a motor cam element 621a defined by the motor element 621. As described herein, the selective arrangement of the plurality of plate elements 623 between a first directional configuration and a second directional configuration may correspond to an adjustment of the angular configuration defined by each of the plurality of plate elements 623 relative to the air outlet 612 defined at the sidewall surface of the fan component 610. For example, the selectively configurable configuration of the air distribution system 620 may be defined, at least in part, by a motor-driven reconfiguration of the plurality of plate elements 623 from a first directional configuration defined to a second directional configuration that causes an airflow direction characteristic defined by the volume of air travelling through the air distribution system 620 to be adjusted. In such an exemplary circumstance, the exemplary respiratory protective device 600 may utilize the air distribution system 620 to selectively adjust one or more airflow characteristics of a volume of air received from the fan component 610, such as, for example, the airflow direction defined by the volume of air as it flows into the interior portion of the inner shell component 601, prior to and/or as the volume of air is being delivered from one or more air channels defined by the inner shell component 601 into the interior portion thereof (e.g., via the air distribution system 620).

For example, the air distribution system 620 may be arranged relative to the one or more air outlets defined by the fan component 610 such that an air flow characteristic of the volume of air flowing from the fan component 610 via the one or more air outlet may be defined and/or at least partially affected by the position of the plurality of plate elements 623 of the air distribution system 620 (e.g., between a first plate position and a second plate position).

In various embodiments, the air distribution system 620 may be arranged relative to the fan component 610 such that a rearrangement, a reconfiguration, and/or an otherwise selective movement of one or more components of the air distribution system 620, such as, for example, a linking rod 622b and/or the plurality of plate elements 623, between a first configuration and a second configuration (e.g., relative to the one or more air outlets 612 defined by the fan component 610) may define a selective adjustment of at least one air flow characteristic defined by a volume of air flowing through and/or from the one or more air outlet 612 of the fan component 610. As a non-limiting example, in various embodiments, the air distribution system 620 may be configured such that the at least one air flow characteristic adjusted based on a reconfiguration thereof may be defined by a change in airflow direction defined by the volume of air flowing through the respiratory protective device 600 relative to the air distribution system 620. As a further non-limiting example, in various embodiments, the air distribution system 620 may be configured such that the at least one air flow characteristic adjusted based on a reconfiguration thereof may be defined by a change in airflow volume defined by the volume of air flowing through the respiratory protective device 600 relative to the air distribution system 620.

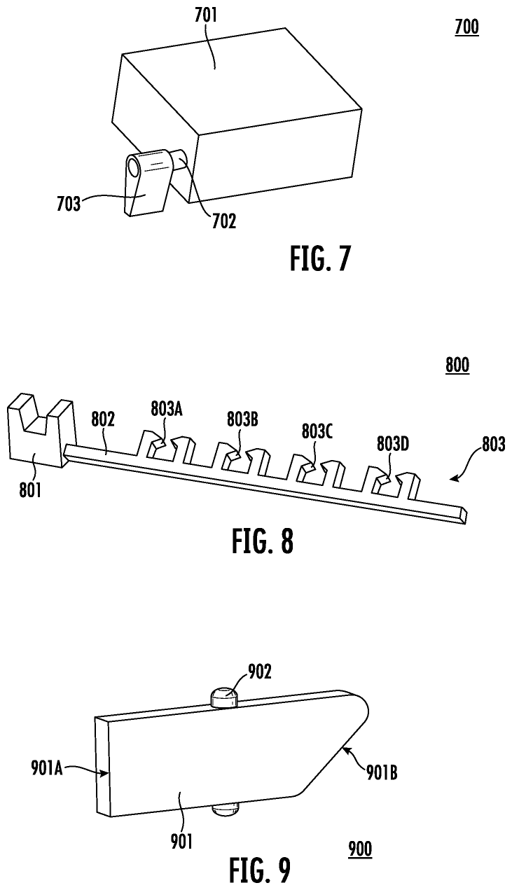

Referring now to FIG. 7, an example motor element 700 of an exemplary air distribution system in accordance with some example embodiments described herein is illustrated. As illustrated in FIG. 7, in various embodiments, an exemplary motor element 700 of an air distribution system may comprise a motor element housing 701, a drive shaft 702, and a motor cam element 703. The motor element 700 may comprise a motor element housing 701 configured to house various mechanical and/or electronic components of the motor element that are configured to cause the drive shaft 702 to rotate in one or more rotational directions based at least in part on a control signal received by the motor element 700 (e.g., from a controller component of the respiratory protective device). Further, the motor element 700 may comprise a motor cam element 703 fixedly secured relative to a distal end of the drive shaft 702 such that the motor cam element 703 is configured to rotate with the drive shaft 702 in one or more rotational directions about the central axis of the drive shaft 702. As described herein, the motor element 700 may be configured to cause the drive shaft 702 and the motor cam element 703 attached thereto to rotate about the central axis of the drive shaft 703.

The motor element 700 may be configured such that the rotational motion of the drive shaft 702 and the motor cam element 703 fixedly attached thereto may cause a corresponding movement of at least a distal portion of the motor cam element 703 in one or more at least partially linear directions. For example, in various embodiments, as described herein, a rotation of motor cam element 703 resulting from the rotation of the drive shaft 702 in a rotational direction may be defined by a distal end of motor cam element 703 exhibiting a movement that is defined at least partially in a linear direction, and one or more components of the air distribution system physically engaged with the distal end of motor cam element 703 exhibiting a corresponding linear movement driven by motor cam element 703. For example, the motor cam element 703 may be configured to engage at least a portion of an exemplary linking element (e.g., a motor engagement element) of the air distribution system such that a rotation of the motor cam element 703 about the central axis of the drive shaft 702 may cause the linking element to exhibit a corresponding linear movement (e.g., in either a first or second linear direction). As described herein, the motor element 700 may be configured to drive a rotation of the motor cam element 703 in one or more rotational directions to transmit one or more linear pushing forces (e.g., and/or pulling forces) to the linking element engaged therewith in order to facilitate an adjustment of the air distribution system between a first configuration and a second configuration, as described herein.

Referring now to FIG. 8, an example linking element 800 of an exemplary air distribution system in accordance with some example embodiments described herein is illustrated. As illustrated in FIG. 8, in various embodiments, an exemplary linking element 800 of an air distribution system may comprise a motor engagement element 801, a linking rod 802, and a plurality of plate engagement features 803. As illustrated, in various embodiments, the exemplary linking element 800 may comprise a motor engagement element 801 configured to facilitate a physical connection between the linking element 800 and a motor element of an air distribution system such that the movement of the linking element 800 may be driven by the motor element. For example, the motor engagement element 801 may be configured to physically engage a motor cam element of a motor element defined by the air distribution system (e.g., motor cam element 703 described in reference to FIG. 7) such that the motor engagement element 801 is configured to be linearly translated in a first linear direction and/or an opposite second linear direction in response to a motor cam element engaged therewith being rotated in a first rotational direction and/or a second rotational direction, respectively.

In various embodiments, the motor engagement element 801 of the linking element may be fixedly secured to a linking rod 802 defined by the linking element 800. For example, the motor engagement element 801 of the linking element 800 is configured to operatively connect the motor element (e.g., the motor cam element) of the air distribution system to the linking rod 802 such that a rotation of the motor cam element may cause a linear force to be transferred in a corresponding linear direction (e.g., at least partially parallel to a length of the linking rod 802) to the linking rod 802. The linking element 800 may be configured such that a linear force acting on the motor engagement element 801 in a first linear direction as a result of a rotation of the motor cam element in a first rotational direction may be transmitted to the linking rod 802 so as to cause a resultant linear translation of the linking rod 802 (e.g., with the motor engagement element 801) in a corresponding linear direction.

In various embodiments, the linking rod 802 may be attached to each of a plurality of plate engagement features 803 defined by the linking element 800. For example, each of the plurality of plate engagement features 803 may be fixedly secured relative to the linking rod 802 such that a linear movement of the linking rod 802 may cause each of the plurality of plate engagement features 803 to exhibit an at least substantially similar linear movement. As illustrated, the plurality of plate engagement features 803 may be distributed along the length of the linking rod 802, each being configured for attachment relative to at least a portion of a corresponding plate element defined by the air distribution system. In various embodiments, the plurality of plate engagement features 803 may be distributed along the length of the linking rod 802 such that the plurality of plate elements secured relative thereto may be similarly distributed along the linking rod 802 length.

In various embodiments, each of the plurality of plate engagement features 803 may define a clamp element, clasp element, fastening element, or any operable fastening means capable of securing a connection between the linking rod 802 of the linking element 800 and a respective plate element of the plurality defined by the air distribution system. As described herein, a plate engagement feature 803 may be configured to secure a connection relative to a plate element at a proximal plate end thereof such that a linear movement of the linking rod 802 may cause one or more linear forces to be transmitted to the proximal plate end of the plate element to rotate a plate thereof about a corresponding hinge pin, as described herein. As illustrated in FIG. 8, the exemplary linking element 800 comprises a plurality of plate engagement features 803 that includes a first plate engagement feature 803A, a second plate engagement feature 803B, a third plate engagement feature 803C, and a fourth plate engagement feature 803D.

Referring now to FIG. 9, an example plate element 900 of an exemplary air distribution system in accordance with some example embodiments described herein is illustrated. As illustrated in FIG. 9, in various embodiments, an exemplary plate element 900 of an air distribution system may comprise a plate 901 and a hinge pin 902. The plate 901 of an exemplary plate element 900 may be defined between a proximal plate end 901A and a distal plate end 901B, the distal plate end 901B defining the opposite end of the plate 901 (e.g., as measured along the length of the plate 901) relative to the proximal plate end 901A. The plate 901 may be linearly fixed about a hinge pin 902 of the plate element 900 and configured for rotation about a central axis of the hinge pin 902 upon one or more forces acting on the plate 901 (e.g., from the linking element of the air distribution system). For example, as described herein, the plate element 900 may be physically engaged with a linking rod defined by a linking element of the air distribution system (e.g., linking rod 802 of the linking element 800 described in reference to FIG. 8) such that a linear movement of the linking rod relative to the plate element 900 may cause a non-linear moment to be imparted on the plate element 900 about the central axis of the hinge pin 902.

In various embodiments, the plate element 900 may be configured such that the proximal plate end 901A of the plate 901 is physically engaged (e.g., coupled) with a corresponding plate engagement feature of a linking element of the air distribution system (e.g., a plate engagement feature 803 of the linking element 800 described in reference to FIG. 8). In such an exemplary configuration, a movement of the linking element (e.g., driven by the motor element of the air distribution system) in a linear direction relative to the plate element 900, as described herein, may cause a linear force (e.g., a pushing force, a pulling force, and/or the like) to be transmitted to the proximal plate end 901A of the plate 901. The linear force transmitted to the proximal plate end 901A of the hinged plate 901 may cause the plate 901 to rotate in a corresponding rotational direction about the hinge pin 902 of the plate element 900. Further, such an exemplary rotation of the plate 901 about the hinge pin 902 may cause the second lateral end 901B of the plate 901 to be similarly rotated about the hinge pin 902 such that the entirety of the plate 901 is reconfigured from a first plate position to a second plate position. For example, a first plate position defined by the plate element 900 (e.g., the plate 901) may be defined by the length of the plate 901 being provided and/or arranged in a first angular direction (e.g., relative to the hinge pin 902), and a second plate position defined by the plate element 900 (e.g., the plate 901) may be defined by the length of the plate 901 being provided, rotated, and/or otherwise arranged such that the length of the plate 901 is provided in a second angular direction (e.g., relative to the hinge pin 902). Reconfiguring the plate element 900 from a first plate position to a second plate position may be defined at least in part by a rotation of the plate 901 from the first plate position through an angle of rotation to the second plate position. For example, the second angular direction defined by a plate element 900 may be separated from the first angular direction by an angle of separation that is defined by the above-described angle of rotation, as measured about the central axis of the hinge pin 902.

FIGS. 10A-10B illustrate example isolated perspective views of an example air distribution system for an example respiratory protective device in accordance with some example embodiments described herein. In particular, FIGS. 10A and 10B illustrate an exemplary air distribution system 1000 of a respiratory protective device configured in a first configuration defined by an arrangement of a plurality of plate elements 1030 in a first directional configuration and a second configuration defined by an arrangement of the plurality of plate elements 1030 in a second directional configuration, respectively.

The exemplary air distribution system 1000 illustrated in FIGS. 10A and 10B is configured for use with a respiratory protective device, as described herein, and comprises a motor element 1010, a linking element 1020, and a plurality of plate elements 1030. The exemplary air distribution system is configured to utilize the motor element 1010 to drive a movement of the motor cam element 1013 and, thus, a corresponding movement of the linking element 1020 (e.g., the motor engagement feature 1021) engaged therewith, thereby causing the plurality of plate elements 1030 to be reconfigured such that one or more of the airflow characteristics defined by a volume of air that interacts with the air distribution system 1000 (e.g., upon being exhausted from a fan component) is selectively adjusted based on the change in directional configuration exhibited by the plurality of plates 1030. As illustrated, and as described herein, each of the plurality of plate elements 1030 of the air distribution system 1000 may be selectively rotated about a respective rotational axis defined by a hinge pin thereof between a first directional configuration (e.g., shown in FIG. 10A) and a second directional configuration (e.g., shown in FIG. 10B) to facilitate the selective reconfiguration of the air distribution system 1000 between a first configuration and a second configuration, such as, for example, in order to selectively adjust one or more airflow characteristics of a volume of air flowing through a respiratory protective device.

In various embodiments, the directional configuration of at least a portion of the plurality of plates defined by the plurality of plate elements 1030 may define, at least in part, the configuration (e.g., directional configuration) of the air distribution system 1000 (e.g., relative to an air outlet of a fan component). For example, at least a portion of the plurality of plate elements 1030 in an air distribution system 1000 may be configurable between a first directional configuration defined by each of the plurality of plate elements 730 (e.g., each of the plurality of plates defined thereby) being arranged to point in a first direction, and a second directional configuration defined by each of the plurality of plate elements 1030 being arranged to point in a second direction, as illustrated in FIGS. 10A and 10B, respectively. The directional arrangement of the plate elements 1030 in a first direction, second direction, and/or any other direction defined therebetween, may be defined by the length of the plate defined by a respective plate element 1030 being provided in a respective one of the first, second, or other directions. In various embodiments, each of the plurality of plate elements 1030 of an air distribution system 1000 may be controlled simultaneously such that each of the plurality of plate elements 1030 (e.g., each of the respective plates defined by the plurality of plate elements 1030) is arranged in the same directional configuration.

In various embodiments, an exemplary air distribution system 100 may be configured such that the rotational displacement of the motor cam element 1013 of the motor element 1010 engaged with the motor engagement feature 1021 of the linking element 1020 may cause a force to be exerted from the motor cam element 1013 to the motor engagement feature 1021, and further, from the motor engagement feature 1021 to a first end of the linking rod 1022 connected thereto. For example, as described herein, the linear force transmitted to the motor engagement feature 1021 may be defined by either a pushing force or a pulling force that results in the linear displacement of the motor engagement feature 1021 in a direction and an amount corresponding to the rotational displacement of the motor cam element 1013. Further, the linear force transmitted from the motor engagement feature 1021 to the linking rod 1022 may comprise a corresponding pushing/pulling force and may result in the linear displacement of the linking rod 1022 in a direction and an amount that corresponds to the linear displacement of the motor engagement feature 1021, and thus, similarly corresponds to the rotational displacement of the motor cam element 1013 with which the motor engagement feature 1021 is engaged.

The linking element 1020 of the air distribution system 1000 may be configured such that the linear motion defined by the linking rod 1022 results in a corresponding linear motion of each of the plurality of plate engagement features 1023 secured thereto. In various embodiments, the plurality of plate engagement features 1023 may be configured to maintain a physical engagement with a respective plate element of the plurality 1030 (e.g., a respective one of a first plate element 1031, a second plate element 1032, a third plate element 1033, and a fourth plate element 1034) of the air distribution system 1000 so as to generate a linear directional force that is transmitted to the proximal plate end engaged therewith. As described herein, such an exemplary force transmission may cause the proximal plate end of each of the plurality of plate elements 1030 to undergo a linear displacement mirroring that of the linking rod 1022. As described herein, the linking rod 1022 may be operatively connected to each of the plate elements 1030 (e.g., via a respective plate engagement features 1023) such that the linear movement of each of the proximal plate ends of the plate elements 1030 may result in each of the plurality of plate elements 1030 (e.g., the respective plates) rotating about a respective hinge axis defined by a hinge pin thereof. As illustrated in FIGS. 10A and 10B, such a rotation of each of the plurality of plate elements 1030 about their respective hinge pins may cause the plurality of plates defined thereby to transition from a first directional configuration to a second directional configuration. For example, the direction and magnitude of angular rotation of the plurality of the plates of the plurality of plate elements 1030 may correspond, at least in part, to those of the linear displacement of the linking rod 1022 to which the plurality of plate elements 1030 is operatively attached. As described herein, the directional configuration of each of the plurality of plate elements 1030 of an exemplary air distribution system 1000 may be configured to correspond to the position of the linking element 1020 relative to a fan component (e.g., the one or more air outlets) defined by the respiratory protective device.

Returning to the exemplary embodiment illustrated in FIG. 6, an exemplary respiratory protective device 600 may comprise an air distribution system 620 arranged relative to a fan component 610 such that a volume of air dispensed from an air outlet 612 defined by the fan component 610 is engaged and/or otherwise redirected by at least a portion of the air distribution system 620. For example, the volume of air exhausted from the fan component 610 may be defined by one or more air flow characteristics, such as, for example, an air flow direction, and airflow volume, and/or the like, that may be affected by an interaction with the air distribution system 620 (e.g., the plurality of plates 623). For example, in various embodiments, the air distribution system 620 may define an adjustable configuration relative to the air outlet 612 of the fan component 610 such that the air distribution system 620 may be selectively reconfigured in order to cause a selective adjustment of one or more airflow characteristics defined by the volume of air flowing through the air distribution system 620.

As a non-limiting example, in various embodiments, the air distribution system 620 of an exemplary respiratory protective device 600 may comprise a plurality of plate elements 623 that may be selectively reconfigured from a first directional configuration to a second directional configuration (e.g., via a movement driven by a motor element 621 of the air distribution system 620) in order to selectively adjust the airflow direction of the volume of air to a direction corresponding to the second directional configuration of the plurality of plate elements 623. For example, an exemplary respiratory protective device 600 may be configured to selectively reconfigure the air distribution system 620 (e.g., the plurality of plate elements 623) between a first directional configuration and a second directional configuration in order to selectively adjust the airflow direction defined by the volume of air between a first airflow direction and a second airflow direction corresponding to the first directional configuration and the second directional configuration of the plate elements 623, respectively. As a non-limiting example provided for illustrative purposes, an exemplary air distribution system 620 may be configured to selectively adjust an airflow direction defined by a volume of air flowing from the fan component 610 between a first airflow direction defined from an interior mask air inlet slot in a first direction towards a nose and/or mouth of a user, and a second airflow direction defined from the interior mask air inlet slot in a second direction that is different than the first direction and at least partially away from the nose and/or mouth of the user. For example, in an exemplary embodiments, the first airflow direction may be defined in an at least partially upward direction and the second airflow direction may be defined in an at least partially downward direction, neither of which are pointed directly towards the nose/mouth of the user. The air distribution system 620 may be arranged so as to causes a first volume of air and a second volume of air to be blown into the interior portion of the inner shell component 601 in the first (e.g., at least partially upward) airflow direction and the second (e.g., at least partially downward) airflow direction, respectively, in order to provide an at least substantially uniform distribution of the first and second volumes of air airflow throughout the interior portion.

As a further non-limiting example, in various embodiments, the plurality of plate elements 623 may be selectively reconfigured from a first directional configuration to a second directional configuration, as described herein, in order to selectively adjust (e.g., increase and/or decrease) the airflow volume defined by the volume of air flowing from an air outlet 612 of the fan component 610 and through the openings defined between the plurality of plate elements 630. For example, an exemplary respiratory protective device 600 may be configured to selectively reconfigure the plurality of plate elements 630 between a first directional configuration and a second directional configuration in order to selectively adjust the coverage percentage of the plate elements 630 relative to the surface area of the one or more orifices defining the air outlet 612 of the fan component 610, and/or the amount of flow interference caused by the plurality of plate elements 630 as the volume of air is driven through the openings defined between adjacent plate elements of the plurality 630 (e.g., to adjust an outlet area of an air outlet defined by a downstream portion of the plurality of plate elements 630).

In various embodiments, the air distribution system 620 may be configured to facilitate a selective adjustment of an airflow characteristic defined by the volume of air, such as, for example the airflow direction, based at least in part on or more operating characteristics and/or breathing conditions defined by the respiratory protective device 600 at a particular instance. For example, the airflow volume defined by the volume of air flowing through the air distribution system 620 may be selectively increased and/or decreased by reconfiguring the plurality of plate elements 630 between a first directional configuration and a second directional configuration in order to calibrate the airflow volume defined by the volume of air to an optimized airflow volume determined for one or more identified operating characteristics and/or breathing conditions defined by the respiratory protective device 600. As a further example, the airflow direction defined by the volume of air flowing through the air distribution system 620 may be selectively redirected between a first airflow direction and a second airflow direction by reconfiguring the plurality of plate elements 630 between a first directional configuration and a second directional configuration to calibrate and/or choreograph an adjustment of the airflow direction defined by the volume of air according to one or more identified breathing conditions, such as, for example, breathing depth, breathing frequency, and/or the like, determined by the respiratory protective device 600, as described herein. As described herein, the exemplary air distribution system 620 may be configured to facilitate the selective adjustment of the one or more airflow characteristics defined by the volume of air exhausted from a fan component 610 of the respiratory protective device 600 in order to enable an operation of the respiratory protective device 600 defined by an at least substantially uniform airflow volume being passed from the fan component 610 to the user's nose/mouth.

In various embodiments, an exemplary respiratory protective device 600 may comprise a first centrifugal fan component 610 provided on a left side of the inner shell component 601 and a second centrifugal fan component (not shown) provided on an opposing right side of the inner shell component 601. In such an exemplary configuration, the air distribution system 620 of the respiratory protective device 600 may comprise both a first plurality of plate elements 630 adjustable based on the configuration of a first linking element 622 controlled by a first motor cam element 621a, and a second plurality of plate elements (not shown) adjustable based on the configuration of a second linking element controlled by a second motor cam element of the motor element 621. For example, the air distribution system 620 may be configured to independently control the arrangement of the first plurality of plate elements 623 and the second plurality of plate elements arranged relative to the first and second centrifugal fan components, respectively, such that a first airflow characteristic defined by a first volume of air flowing through the air outlet 612 of the first centrifugal fan component 610 may be selectively adjusted independently of a second airflow characteristic defined by a second volume of air flowing through the air outlet of the second centrifugal fan component (not shown). As in illustrative example, a motor element 621 of an exemplary air distribution system 620 may be operated to arrange a first plurality of plate elements 623 in a first directional configuration such that a first volume of air interacting therewith is defined by a first airflow direction and a second plurality of plate elements (not shown) in a second directional configuration such that a second volume of air interacting therewith is defined by a second airflow direction that is at least substantially different than the first airflow direction. In various embodiments, such independent control of the selective adjustment of both a first plurality of plate elements configured to direct a first volume of air into the interior portion of the inner shell component 601 through a first interior mask air inlet slot and a second plurality of plate elements configured to direct a second volume of air into the interior portion of the inner shell component 601 through a second interior mask air inlet slot enables a uniform distribution of the volumes of air throughout the interior portion via respective indirect flow paths to the user's nose/mouth that mitigates operational failures and/or inefficiencies caused by a blowing effect within the interior portion, and prevents an abrasive and/or uncomfortable circulation of the volume of air from the fan component directly into the face of a user.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An air distribution system for selectively adjusting airflow in a respiratory protective device, the air distribution system comprising:
a motor element; and
one or more plate element configured for movement between at least a first directional configuration and a second directional configuration based at least in part on an operation of the motor element;
wherein the one or more plate element is configured for arrangement relative to an air outlet defined by a fan component of the respiratory protective device such that the movement of the one or more plate elements between the first directional configuration and the second directional configuration defines a selective adjustment of one or more airflow characteristic defined by a volume of air flowing through the respiratory protective device relative to the air distribution system.

2. The air distribution system of claim 1, wherein the one or more airflow characteristic defined by the volume of air comprises an airflow direction.

3. The air distribution system of claim 2, wherein the selective adjustment of the one or more airflow characteristic is defined by a change in the airflow direction defined by the volume of air from a first airflow direction to a second airflow direction.

4. The air distribution system of claim 1, wherein the one or more airflow characteristic defined by the volume of air comprises an airflow volume.

5. The air distribution system of claim 4, wherein the selective adjustment of the one or more airflow characteristic is defined by a change in the airflow volume defined by the volume of air from a first airflow volume to a second airflow volume.

6. The air distribution system of claim 1, wherein the motor element is configured for electronic communication with a controller component defined by the respiratory protective device.

7. The air distribution system of claim 6, wherein the motor element is configured to drive the movement of the one or more plate element between the first directional configuration and the second directional configuration based at least in part on one or more control signals received from the controller component.

8. The air distribution system of claim 1, further comprising a linking element configured to operably connect the motor element to the one or more plate elements.

9. The air distribution system of claim 8, wherein the motor element defines a motor cam element that is selectively configurable between a first motor cam position and a second cam motor position based at least in part on a rotational configuration of a drive shaft defined by the motor element.

10. The air distribution system of claim 9, wherein the motor cam element is physically engaged with the linking element such that an arrangement of the motor cam element between the first motor cam position and the motor second cam position causes a corresponding movement of the linking element.

11. The air distribution system of claim 10, wherein the corresponding movement of the linking element caused by the arrangement of the motor cam element at least partially defines the movement of the one or more plate element between the first directional configuration and the second directional configuration.

12. The air distribution system of claim 11, wherein the air distribution system is configured such that a rotation of the motor cam element about a rotational axis defined by a draft shaft causes an at least partially linear movement of the linking element that drives an angular rotation of the one or more plate element about a respective hinge pin.

13. A method of operating an air distribution system to selectively adjust airflow in a respiratory protective device, the method comprising:
providing an air distribution system comprising:
a motor element; and
one or more plate element configured for movement between at least a first directional configuration and a second directional configuration based at least in part on an operation of the motor element;
wherein the one or more plate element is configured for arrangement relative to an air outlet defined by a fan component of the respiratory protective device; and
selectively adjusting one or more airflow characteristic defined by a volume of air flowing through the respiratory protective device relative to the air distribution system by moving the one or more plate elements between the first directional configuration and the second directional configuration.

14. The method of claim 13, wherein the one or more airflow characteristic defined by the volume of air comprises an airflow direction.

15. The method of claim 14, wherein selectively adjusting the one or more airflow characteristic comprises changing the airflow direction defined by the volume of air from a first airflow direction to a second airflow direction.

16. The method of claim 13, wherein the one or more airflow characteristic defined by the volume of air comprises an airflow volume.

17. The method of claim 16, wherein selectively adjusting the one or more airflow characteristic comprises changing in the airflow volume defined by the volume of air from a first airflow volume to a second airflow volume.

18. The method of claim 13, further comprising transmitting one or more communication signals between the motor element and a controller component defined by the respiratory protective device.

19. The method of claim 13, wherein the air distribution system further comprises a linking element configured to operably connect the motor element to the one or more plate elements.

20. The method of claim 19, further comprising selectively configuring a motor cam element defined by the motor element between a first motor cam position and a second cam motor position based at least in part on a rotational configuration of a drive shaft defined by the motor element.
